(19) United States
(12) Patent Application Publication
(10) Pub. No.: US 2007/0159295 A1
(43) Pub. Date: Jul. 12, 2007

(54) Laser-welded seamless chip resistor

(75) Inventor: Hung-Kuang Wang, Chung Li (TW)

Correspondence Address: TROXELL LAW OFFICE PLLC, SUITE 1404, 5205 LEESBURG PIKE, FALLS CHURCH, VA, 22041, US

(73) Assignee: Nan Juen International Co., Ltd.

(21) Appl. No.: 11/326,500

(22) Filed: Jan. 6, 2006

(51) Int. Cl. H01C 1/012

(52) U.S. Cl. 338/307

(57) ABSTRACT

A laser-welded seamless chip resistor comprises: an alloy plate; and two copper plates laser-welded to both sides of the alloy plate, respectively, wherein the alloy plate and the copper plates are chosen in accordance with a required resistance value. The alloy plate and the copper plates, which are welded together, are punched to have a shape in accordance with the required resistance value. Besides, a practical resistance value of the laser-welded seamless chip resistor is fine adjusted to achieve the required resistance value.

### FIELD OF THE INVENTION

The present invention relates to a laser-welded seamless chip resistor, and more particularly to a seamless chip resistor formed by a laser welding method so as to confine its resistance value to a stable range and to fine adjust its resistance value to achieve the require precision.

### BACKGROUND OF THE INVENTION

The conventional surface mounting chip resistor is formed by electroplating an alloy plate with copper metal, and the formed structured is punched, adjusted for adjusting resistance value, coated with a protection layer, and electroplated with copper electrodes so as to form the required resistor. However, when the alloy plate is electroplated with a layer of copper metal, it is not easy to control the thickness of the copper layer. As a result, the obtained resistor is very unstable. When a detection probe touches the resistor, its resistance value's variation rate is violent. Therefore, it is not easy to adjust the resistance value. As a result, a larger amount of resistors must be weeded out, and the manufacture cost is unavoidably high.

### SUMMARY OF THE INVENTION

In view of the drawbacks caused by the conventional manufacture method of the conventional chip resistor, an object of the present invention is to disclose a laser-welded seamless chip resistor that has stable quality and is suitable for mass production.

In order to achieve this object, the chip resistor of the present invention is characterized in seamless welding an alloy plate with two copper plates by a laser welding machine for overcoming the problems of unstable resistance value and poor precision occurred in the conventional structure.

Accordingly, the present invention discloses a laser-welded seamless chip resistor. The laser-welded seamless chip resistor comprises an alloy plate welded with two copper plates by a laser welding machine, wherein the alloy plate and the copper plates are chosen in accordance with the required resistance value. The welded alloy plate and the copper plates are punched to have a predetermined shape in accordance with the required resistance value. Besides, a practical resistance value of the laser-welded seamless chip resistor is probed and fine adjusted by a laser cutting machine to achieve the required resistance value, whereby the inaccuracy of the resistance value of the adjusted chip resistor is less than 1%. Thereafter; a protection layer is formed on both sides of the alloy plate. The obtained structure is further punched to separate the connected chip resistors from one another. Thereafter, the copper plates, which are exposed to the outside of the protection layer, are electroplated with Ni and Sn so as to facilitate the connection between the chip resistor and a circuit board.

The copper plates of the present invention are coupled to the alloy plate precisely since they are laser-welded together, whereby the practical resistance value can be controlled precisely. Besides, the practical resistance value of the chip resistor can be fine adjusted after it is punched so as to obtain the predetermined resistance value. Accordingly, the yield is nearly 100%.

### BRIEF DESCRIPTION OF THE DRAWINGS

FIG. 1 is a three-dimensional view showing the alloy plate of the present invention.

FIG. 2 is a three-dimensional view -showing that the copper plates of the present invention are welded to both sides of the alloy plates.

FIG. 3 is a three-dimensional view showing that the structure of the present invention is punched to form the required shape.

FIG. 4 is a three-dimensional view showing the adjustment of the resistance value by use of the laser cutting method of the present invention.

FIG. 5 is a view showing the protection layer coated on both sides of the alloy plate of the present invention.

FIG. 6 is a view showing the electrodes formed on both sides of the copper plates of the present invention.

### DETAILED DESCRIPTION OF THE PREFERRED EMBODIMENT

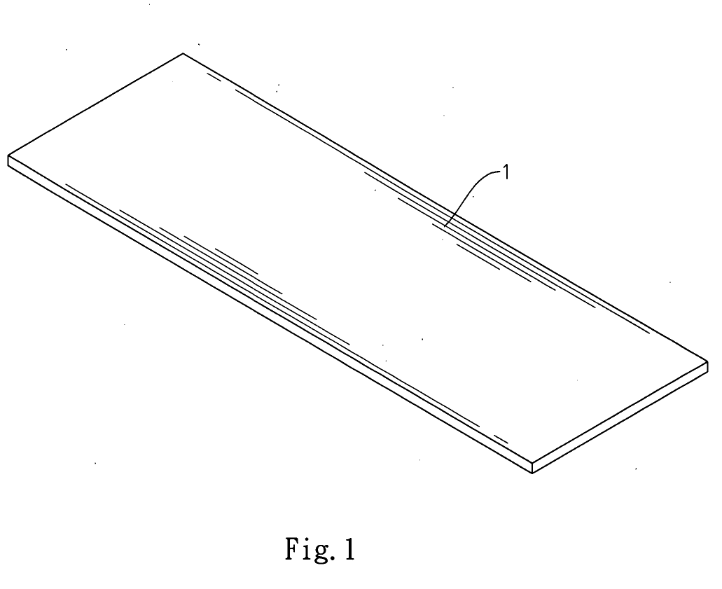

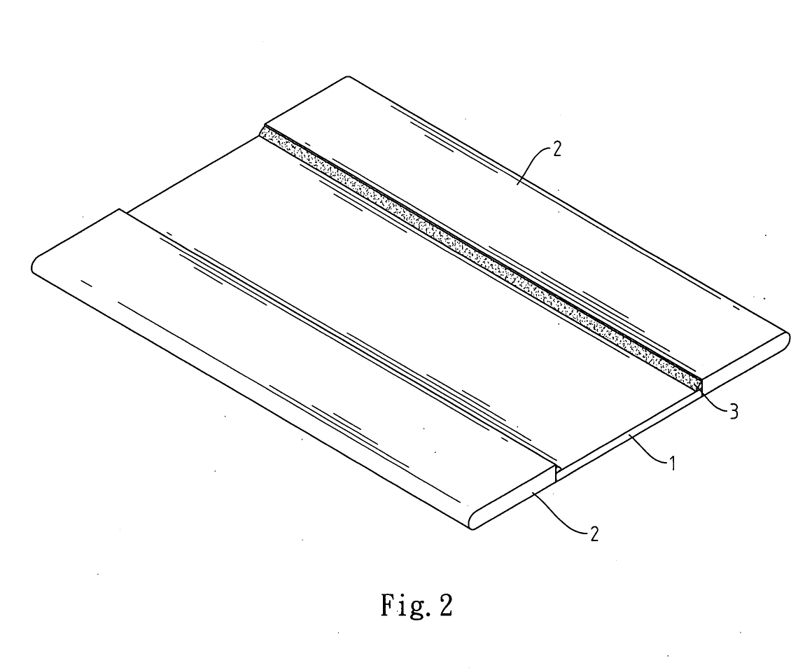

Referring to FIG. 1 and FIG. 2, a laser-welded seamless chip resistor comprises a bar-shaped alloy plate 1 and two copper plates 2, which are welded together by a laser welding method, wherein the alloy plate 1 and the copper plates 2 (or the copper alloys) are chosen in accordance with the required resistance value. By use of a laser welding machine, the copper plates 2 are oppositely laser-welded to both sides of the alloy plate 1 where the electrodes intend to be formed. As a result, the welding connections 3 between the copper plates 2 and the alloy plate 1 are seamless. Accordingly, the welding connections 3 between the copper plates 2 and the alloy plate 1 are precise and accurate. Besides, it is very easy to form the welding connections, and there is almost no difference between the practical resistance value and the required resistance value when these two kinds of metal plates of different materials are welded together.

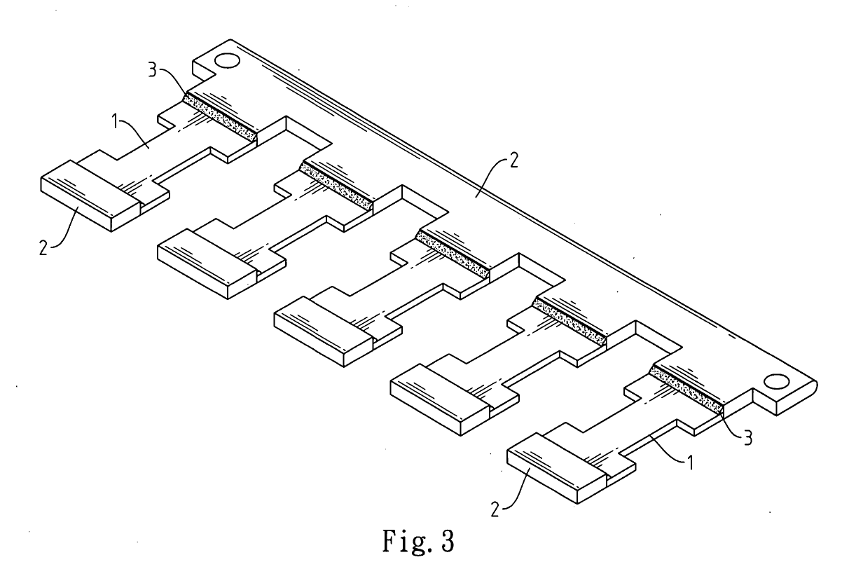

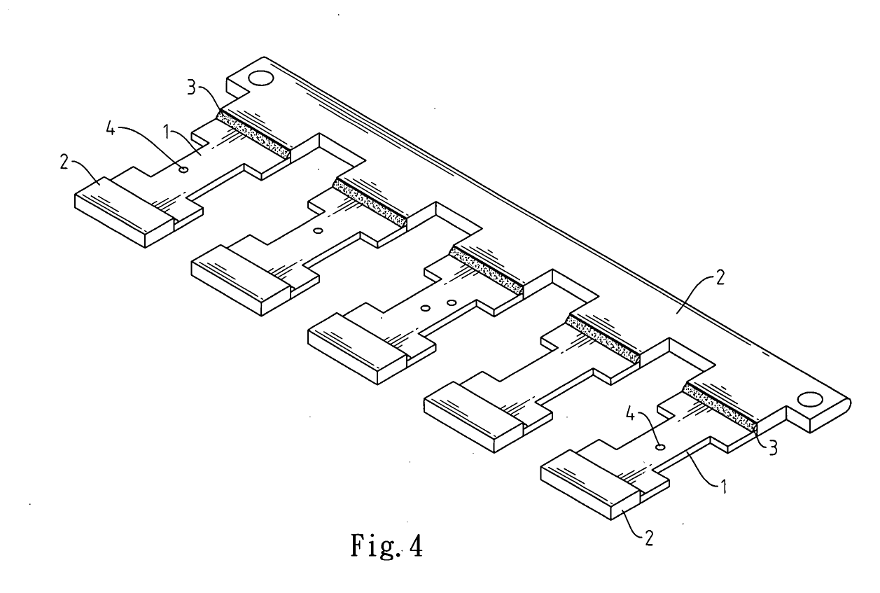

Referring further to FIG. 3 and FIG. 4, when the alloy plate 1 is welded with the high heat-conductive copper plates 2, a punching step is performed on the obtained structure to provide the chip resistor with a shape in accordance with the required resistance value. Besides, one side of the alloy plate 1 is also cut to facilitate the probing step of the practical resistance value. Because minor inaccuracy may be caused during the punching step mentioned above, a laser cutting method is optionally performed by a laser cutting machine to form a cut region 4 on the alloy plate 1 for fine adjusting its practical resistance value, whereby the inaccuracy of the resistance value of the adjusted chip resistor is less than 1%. As a result, only a fairly small amount of products must be weeded out.

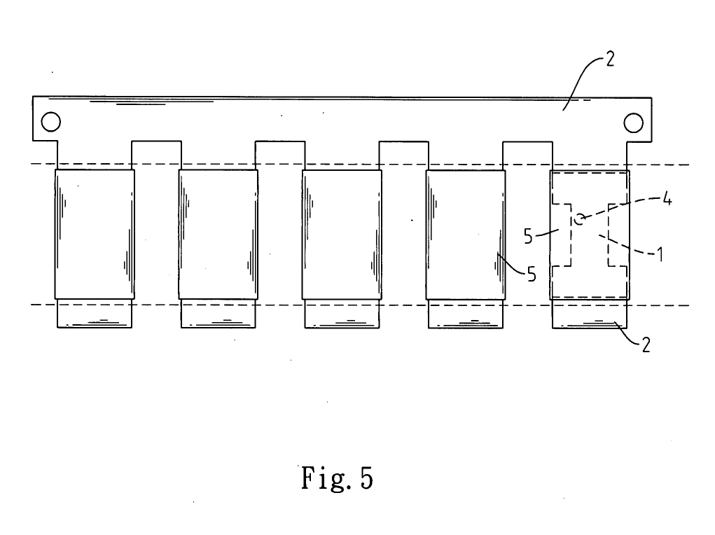

Referring to FIG. 5, a protection layer 5 is formed by coating a layer of epoxy resin on both sides of the above-mentioned punched and adjusted chip resistor for protecting and insulating the chip resistor. However, for the purpose of obtaining electrical connection between the chip resistor and the circuit board, the copper plates 2, which are welded to both sides of the alloy plate 1, must be exposed.

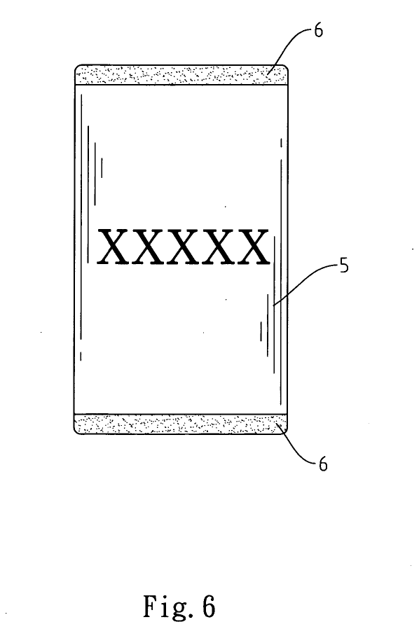

Referring continuously to FIG. 6, when the chip resistors are covered with the protection layers 5, another punching step is performed on the chip resistors individually to separate the connected chip resistors from one another. Finally, the copper plates, which are exposed to the outside of the protection layer 5, are electroplated with Ni and Sn so as to form electrodes 6 for improving the poor connection between tin and copper.

From the above-mentioned structure, it is apparent that the laser-welded seamless chip resistor has simple structure and can simplify the manufacture process. Moreover, the precision of the resistance value of the chip resistor is assured. As a result, the laser-welded seamless chip resistor of the present invention is novel and achieves the anticipated practical utility and efficacy. In comparison with the conventional electroplating method, the present invention provides more advantages and improvements and is indeed a novel and practical invention.

What the invention claimed is:

1. A laser-welded seamless chip resistor comprising:
a bar-shaped alloy plate; and
two copper plates laser-welded oppositely to both sides of the bar-shaped alloy plate, wherein the bar-shaped alloy plate and the copper plates are chosen in accordance with a required resistance value.

2. The laser-welded seamless chip resistor of claim 1, wherein the bar-shaped alloy plate and the copper plates, which are welded together, are punched to have a shape in accordance with the required resistance value.

3. The laser-welded seamless chip resistor of claim 2, wherein a practical resistance value of the laser-welded seamless chip resistor is fine adjusted by a laser cutting method.
